(19) United States
(12) Patent Application Publication
(10) Pub. No.: US 2025/0022650 A1
(43) Pub. Date: Jan. 16, 2025

(54) COIL ELECTRONIC COMPONENT

(71) Applicant: SAMSUNG ELECTRO-MECHANICS CO., LTD., Suwon-si (KR)

(72) Inventors: Donghwan Lee, Suwon-si (KR); Dong Jin Lee, Suwon-si (KR); Soonkwang Kwon, Suwon-si (KR); Tae Hyun Kim, Suwon-si (KR); Daehyung You, Suwon-si (KR)

(73) Assignee: SAMSUNG ELECTRO-MECHANICS CO., LTD., Suwon-si (KR)

(21) Appl. No.: 18/634,352

(22) Filed: Apr. 12, 2024

(30) Foreign Application Priority Data
Jul. 11, 2023 (KR) 10-2023-0089551

(51) Int. Cl. H01F 27/28; H01F 27/26; H01F 27/29; H01F 27/30

(52) U.S. Cl. CPC H01F 27/2852; H01F 27/266; H01F 27/292; H01F 27/306

(57) ABSTRACT

A coil electronic component may include a magnetic body that has a first surface and a second surface facing each other, a first coil embedded in the magnetic body and wound around a first core, a second coil embedded in the magnetic body and wound around a second core that is spaced apart from the first core, a first external electrode and a second external electrode disposed on the second surface of the magnetic body and connected to the first coil, and a third external electrode and a fourth external electrode disposed on the second surface of the magnetic body and connected to the second coil, and a first distance from the first coil and the second coil to the first surface is larger than a second distance from the first coil and the second coil to the second surface.

### CROSS-REFERENCE TO RELATED APPLICATION

This application claims priority to and the benefit of Korean Patent Application No. 10-2023-0089551 filed in the Korean Intellectual Property Office on Jul. 11, 2023, the entire contents of which are incorporated herein by reference.

### BACKGROUND

### Technical Field

The present disclosure relates to a coil electronic component.

### Description of the Related Art

In recent years, as the functionality of mobile devices has diversified, power consumption has increased. For this reason, coil electronic components with low loss and high efficiency have been adopted around power management integrated circuits (PMICs) in order to increase the usage times of the batteries in the mobile devices.

When a coil electronic component has a coupled inductor structure in which a first coil and a second coil are arranged vertically, even if the length of the first coil and the length of the second coil are the same, DC resistance (Rdc) may increase as the lengths of external electrodes which are coupled to the first coil and the second coil increase. For this reason, a method for reducing the DC resistance of the coils in a coupled inductor structure is required.

### SUMMARY

An aspect of embodiments attempts to provide a coil electronic component capable of reducing the DC resistance of coils in a coupled inductor structure.

However, objects which the embodiments attempt to achieve are not limited to the above-mentioned object, and can be variously expanded without the technical spirit and scope of the embodiments.

A coil electronic component according to an embodiment may include a magnetic body that has a first surface and a second surface facing each other and including a first core and a second core spaced apart from the first core, a first coil embedded in the magnetic body and wound around the first core, a second coil embedded in the magnetic body and wound around the second core, a first external electrode and a second external electrode disposed on the second surface of the magnetic body and connected to the first coil, and a third external electrode and a fourth external electrode disposed on the second surface of the magnetic body and connected to the second coil, and a first distance from the first coil and the second coil to the first surface is larger than a second distance from the first coil and the second coil to the second surface.

Further, a difference between the first distance and the second distance may be in a range from 5 μm to 160 μm.

Also, the coil electronic component may further include a support member that has a first support surface facing the first surface of the magnetic body and a second support surface facing the second surface of the magnetic body, and the first coil may include a first coil pattern that is disposed on the first support surface of the support member, a second coil pattern that is disposed on the second support surface of the support member, and a first via that passes through the support member and connects the first coil pattern and the second coil pattern, and the second coil may include a third coil pattern that is disposed on the first support surface of the support member, a fourth coil pattern that is disposed on the second support surface of the support member, and a second via that passes through the support member and connects the third coil pattern and the fourth coil pattern.

Further, the first coil pattern may include a first winding pattern wound around the first core, and a first extension pattern wound to surround the first core and the second core, and the second coil pattern may include a second winding pattern wound around the first core, and a second extension pattern wound to surround the first core and the second core, and the third coil pattern may include a third winding pattern wound around the second core, and a third extension pattern wound to surround the first core and the second core, and the fourth coil pattern may include a fourth winding pattern wound around the second core, and a fourth extension pattern wound to surround the first core and the second core.

Furthermore, a winding direction of the first winding pattern and a winding direction of the second winding pattern may be opposite to each other, and a winding direction of the third winding pattern and a winding direction of the fourth winding pattern may be opposite to each other.

Moreover, the winding direction of the first winding pattern and the winding direction of the third winding pattern may be the same as each other, and the winding direction of the second winding pattern and the winding direction of the fourth winding pattern may be the same as each other.

Also, the winding direction of the first winding pattern and a winding direction of the first extension pattern may be the same as each other, and the winding direction of the second winding pattern and the winding direction of a second extension pattern may be the same as each other.

Further, the winding direction of the third winding pattern and a winding direction of the third extension pattern may be the same as each other, and the winding direction of the fourth winding pattern and a winding direction of the fourth extension pattern may be the same as each other.

Furthermore, the first coil pattern may include a first winding pattern wound around the first core, and a first extension pattern wound to surround the first core and the second core, and the second coil pattern may include a second winding pattern wound around the first core, and a second extension pattern that extends from the second winding pattern toward the second core, and the third coil pattern may include a third winding pattern wound around the second core, and a third extension pattern wound to surround the first core and the second core, and the fourth coil pattern may include a fourth winding pattern wound around the second core, and a fourth extension pattern that extends from the fourth winding pattern toward the first core.

Moreover, a winding direction of the first winding pattern and a winding direction of the second winding pattern may be opposite to each other, and a winding direction of the third winding pattern and a winding direction of the fourth winding pattern may be opposite to each other.

Also, the winding direction of the first winding pattern and the winding direction of the third winding pattern may be the same as each other, and the winding direction of the second winding pattern and the winding direction of the fourth winding pattern may be the same as each other.

Further, the winding direction of the first winding pattern and a winding direction of the first extension pattern may be the same as each other, and the winding direction of the third winding pattern and a winding direction of the third extension pattern may be the same as each other.

Furthermore, the first coil pattern may include a first winding pattern wound around the first core, and a first extension pattern that extends from the first winding pattern toward the second core, the second coil pattern may be wound to surround the first core and the second core, the third coil pattern may include a third winding pattern wound around the second core, and a third extension pattern that extends from the third winding pattern toward the first core, and the fourth coil pattern may be wound to surround the first core and the second core.

Moreover, a winding direction of the first winding pattern and a winding direction of the second winding pattern may be opposite to each other, and a winding direction of the third winding pattern and a winding direction of the fourth winding pattern may be opposite to each other.

In addition, the winding direction of the first winding pattern and the winding direction of the third winding pattern may be the same as each other, and the winding direction of the second winding pattern and the winding direction of the fourth winding pattern may be the same as each other.

Also, the coil electronic component may further include a first connection electrode that is embedded in the magnetic body and connects the first external electrode to the first coil, a second connection electrode that is embedded in the magnetic body and connects the second external electrode to the first coil, a third connection electrode that is embedded in the magnetic body and connects the third external electrode to the second coil, and a fourth connection electrode that is embedded in the magnetic body and connects the fourth external electrode to the second coil.

Further, the coil electronic component may further include a first dummy pad that is embedded in the magnetic body, and is spaced apart from the first coil, and through which the first connection electrode passes, and a second dummy pad that is embedded in the magnetic body, and is spaced apart from the second coil, and through which the second connection electrode passes.

Furthermore, the magnetic body may further have a third surface and a fourth surface that face each other and connect the first surface and the second surface, and the first coil may include a first lead-out portion extending from the third surface and connected to the first external electrode, and a second lead-out portion extending from the fourth surface and connected to the second external electrode, and the second coil may include a third lead-out portion extending from the fourth surface and connected to the third external electrode, and a fourth lead-out portion extending from the third surface and connected to the fourth external electrode.

Moreover, the magnetic body may further have a third surface and a fourth surface that face each other and connect the first surface and the second surface, and the first coil may include a first lead-out portion extending from the third surface and connected to the first external electrode, and a second lead-out portion extending from the third surface and connected to the second external electrode, and the second coil may include a third lead-out portion extending from the fourth surface and connected to the third external electrode, and a fourth lead-out portion extending from the fourth surface and connected to the fourth external electrode.

The magnetic body may further have (i) a first cover layer between the first surface and the first coil and between the first surface and the second coil, and (ii) a second cover layer between the second surface and the first coil and between the second surface and the second coil, and the first cover layer may be thicker than the second cover layer.

A difference between a thickness of the first cover layer and a thickness of the second cover layer may be in a range of from 5 μm to 160 μm.

The first external electrode, the second external electrode, the third external electrode, and the fourth external electrode may not be disposed on the first surface.

According to the coil electronic component of the embodiment, it is possible to reduce the DC resistance of coils in a coupled inductor structure.

### BRIEF DESCRIPTION OF THE DRAWINGS

FIG. 1 is a view schematically illustrating a coil electronic component according to an embodiment.

FIG. 2 is a plan view schematically illustrating the coil electronic component of FIG. 1.

FIG. 3 is a view schematically illustrating a first coil pattern and a third coil pattern shown in FIG. 1.

FIG. 4 is a view schematically illustrating a second coil pattern and a fourth coil pattern shown in FIG. 1.

FIG. 5 is a schematic cross-sectional view taken along line V-V′ in FIG. 1.

FIG. 6 is a view schematically illustrating a coil electronic component according to another embodiment.

FIG. 7 is a view schematically illustrating a first coil pattern and a third coil pattern shown in FIG. 6.

FIG. 8 is a view schematically illustrating a second coil pattern and a fourth coil pattern shown in FIG. 6.

FIG. 9 is a cross-sectional view schematically illustrating a coil electronic component according to another embodiment.

FIG. 10 is a view schematically illustrating a first coil pattern and a third coil pattern shown in FIG. 9.

FIG. 11 is a view schematically illustrating a second coil pattern and a fourth coil pattern shown in FIG. 9.

FIG. 12 is a view schematically illustrating a coil electronic component according to another embodiment.

FIG. 13 is a view schematically illustrating some constituent elements of the coil electronic component of FIG. 12.

FIG. 14 is a view schematically illustrating a coil electronic component according to another embodiment.

FIG. 15 is a view schematically illustrating some constituent elements of the coil electronic component of FIG. 14.

### DETAILED DESCRIPTION

Hereinafter, embodiments of the present disclosure will be described in detail with reference to the accompanying drawings such that those skilled in the art can easily implement them. The drawings and description are to be regarded as illustrative in nature and not restrictive. Like reference numerals designate like elements throughout the specification. Further, some constituent elements in the drawing may be exaggerated, omitted, or schematically illustrated, and a size of each constituent element does not reflect the actual size entirely.

The accompanying drawings are provided for helping to easily understand embodiments disclosed in the present specification, and the technical spirit disclosed in the present specification is not limited by the accompanying drawings, and it will be appreciated that the present disclosure includes all of the modifications, equivalent matters, and substitutes included in the spirit and the technical scope of the present disclosure.

Terms including an ordinary number, such as first and second, are used for describing various constituent elements, but the constituent elements are not limited by the terms. The terms are used only to discriminate one constituent element from another constituent element.

Further, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is “on” a reference portion, the element is located above or below the reference portion, and it does not necessarily mean that the element is located “above” or “on” in a direction opposite to gravity.

Throughout the specification, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance. Therefore, unless explicitly described to the contrary, the word “comprise”, and variations such as “comprises” or “comprising”, will be understood to imply the inclusion of stated elements but not the exclusion of any other elements.

Further, throughout the specification, when it is referred to as “on a plane”, it means when a target part is viewed from above, and when it is referred to as “on a cross-section”, it means when the cross-section obtained by cutting a target part vertically is viewed from the side.

Further, throughout the specification, when it is referred to as “connected”, this does not only mean that two or more constituent elements are directly connected, but may mean that two or more constituent elements are indirectly connected through another constituent element, are physically connected, electrically connected, or are integrated even though two or more constituent elements are referred as different names depending on a location and a function.

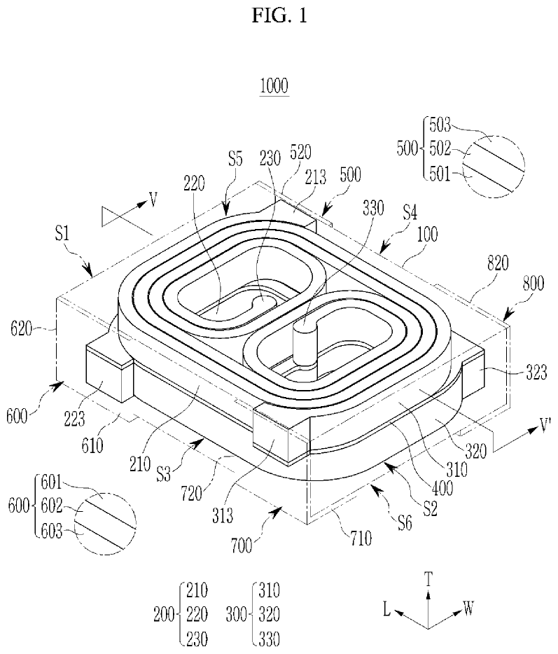

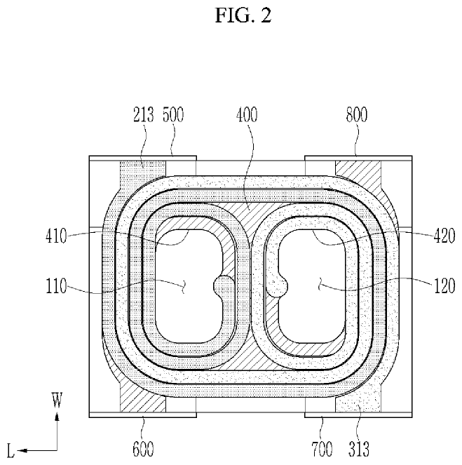

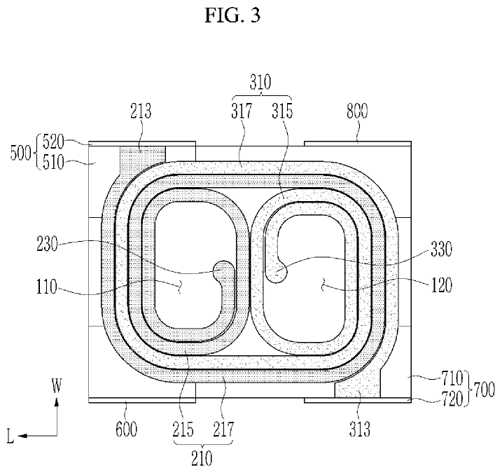

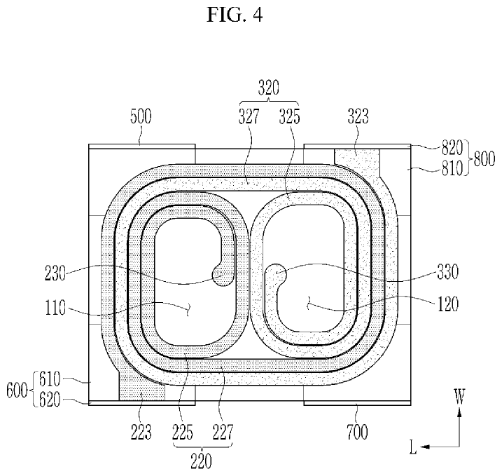

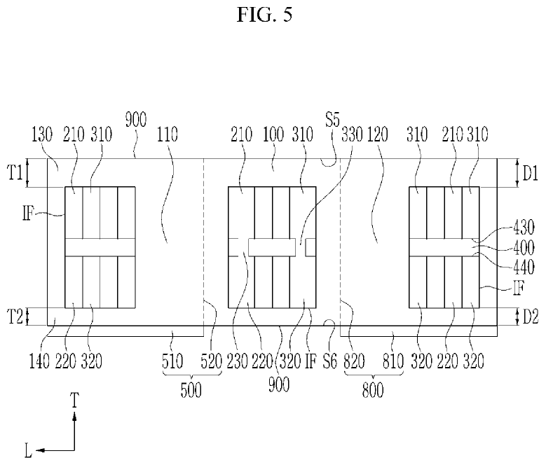

FIG. 1 is a view schematically illustrating a coil electronic component according to an embodiment, and FIG. 2 is a plan view schematically illustrating the coil electronic component of FIG. 1, and FIG. 3 is a view schematically illustrating a first coil pattern and a third coil pattern shown in FIG. 1, and FIG. 4 is a view schematically illustrating a second coil pattern and a fourth coil pattern shown in FIG. 1, and FIG. 5 is a schematic cross-sectional view taken along line V-V′ in FIG. 1.

Referring to FIG. 1, FIG. 2, FIG. 3, FIG. 4, and FIG. 5, a coil electronic component 1000 according to an embodiment includes a magnetic body 100, a first coil 200, a second coil 300, a support member 400, a first external electrode 500, a second external electrode 600, a third external electrode 700, and a fourth external electrode 800.

The magnetic body 100 may have a substantially cuboid shape, but the present embodiment is not limited thereto. Due to shrinkage of magnetic powder during sintering, the magnetic body 100 may have a substantially cuboid shape, although not a perfect cuboid shape. For example, the magnetic body 100 may have a substantially cuboid shape but may have rounded edges or vertices.

In the present embodiment, for ease of explanation, two surfaces of the magnetic body facing each other in the length direction (L-axis direction) are defined as a first surface S1 and a second surface S2, respectively, and two surfaces of the magnetic body facing each other in the width direction (W-axis direction) are defined as a third surface S3 and a fourth surface S4, respectively, and two surfaces of the magnetic body facing each other in the thickness direction (T-axis direction) are defined as a fifth surface S5 and a sixth surface S6, respectively.

A length of the coil electronic component 1000 may refer to the maximum of the lengths of a plurality of line segments, each of which connects two outermost boundary lines of the coil electronic component 1000 facing each other in the length direction (L-axis direction), shown in an optical microscope photograph or SEM (Scanning Electron Microscope) photograph of the lengthwise (L-axis direction) and thickness-wise (T-axis direction) cross section of the coil electronic component 1000 at the center in the width direction (W-axis direction), and is parallel to the length direction (L-axis direction). Alternatively, the length of the coil electronic component 1000 may refer to the minimum of the lengths of a plurality of line segments, each of which connects two outermost boundary lines of the coil electronic component 1000 facing each other in the length direction (L-axis direction), shown in the above-mentioned cross section photograph and is parallel to the length direction (L-axis direction). Or, the length of the coil electronic component 1000 may refer to the arithmetic average of the lengths of at least two line segments of a plurality of line segments, each of which connects two outermost boundary lines of the coil electronic component 1000 facing each other in the length direction (L-axis direction), shown in the above-mentioned cross section photograph and is parallel to the length direction (L-axis direction).

A thickness of the coil electronic component 1000 may refer to the maximum of the lengths of a plurality of line segments, each of which connects two outermost boundary lines of the coil electronic component 1000 facing each other in the thickness direction (T-axis direction), shown in an optical microscope photograph or SEM (Scanning Electron Microscope) photograph of the lengthwise (L-axis direction) and thickness-wise (T-axis direction) cross section of the coil electronic component 1000 at the center in the width direction (W-axis direction), and is parallel to the thickness direction (T-axis direction). Alternatively, the thickness of the coil electronic component 1000 may refer to the minimum of the lengths of a plurality of line segments, each of which connects two outermost boundary lines of the coil electronic component 1000 facing each other in the thickness direction (T-axis direction), shown in the above-mentioned cross section photograph and is parallel to the thickness direction (T-axis direction). Or, the thickness of the coil electronic component 1000 may refer to the arithmetic average of the lengths of at least two line segments of a plurality of line segments, each of which connects two outermost boundary lines of the coil electronic component 1000 facing each other in the thickness direction (T-axis direction), shown in the above-mentioned cross section photograph and is parallel to the thickness direction (T-axis direction).

A width of the coil electronic component 1000 may refer to the maximum of the lengths of a plurality of line segments, each of which connects two outermost boundary lines of the coil electronic component 1000 facing each other in the width direction (W-axis direction), shown in an optical microscope photograph or SEM (Scanning Electron Microscope) photograph of the lengthwise (L-axis direction) and width-wise (W-axis direction) cross section of the coil electronic component 1000 at the center in the thickness direction (T-axis direction), and is parallel to the width direction (W-axis direction). Alternatively, the width of the coil electronic component 1000 may refer to the minimum of the lengths of a plurality of line segments, each of which connects two outermost boundary lines of the coil electronic component 1000 facing each other in the width direction (W-axis direction), shown in the above-mentioned cross section photograph and is parallel to the width direction (W-axis direction). Or, the width of the coil electronic component 1000 may refer to the arithmetic average of the lengths of at least two line segments of a plurality of line segments, each of which connects two outermost boundary lines of the coil electronic component 1000 facing each other in the width direction (W-axis direction), shown in the above-mentioned cross section photograph and is parallel to the width direction (W-axis direction).

Further, each of the length, width, and thickness of the coil electronic component 1000 may be measured using a micrometer measurement method. In the micrometer measurement method, a zero point is set with a micrometer providing repeatability and reproducibility (Gage R&R), the coil electronic component 1000 according to the present embodiment is inserted between tips of the micrometer, and a measuring lever of the micrometer is turned for the measurement. Meanwhile, when the length of the coil electronic component 1000 is measured by the micrometer measurement method, the length of the coil electronic component 1000 may refer to a single measured value, or may refer to an arithmetic average of a plurality of measured values. This may be equally applied to measuring the width and thickness of the coil electronic component 1000.

The magnetic body 100 constitutes an exterior of the coil electronic component 1000, and has a space where a magnetic path, which is a path through which the magnetic flux induced by the first coil 200 and the magnetic flux induced by the second coil 300 pass, is formed, when current is applied to the first coil 200 through the first external electrode 500 and the second external electrode 600 and current is applied to the second coil 300 through the third external electrode 700 and the fourth external electrode 800.

The magnetic body 100 encapsulates the first coil 200, the second coil 300, and the support member 400, and includes a magnetic material. The magnetic body 100 includes magnetic particles, and an insulating material may be interposed between the magnetic particles.

The magnetic material may contain first metal magnetic powder, second metal magnetic powder having particle diameters larger than those of the first metal magnetic powder, and third metal magnetic powder having particle diameters larger than those of the second metal magnetic powder. The average particle diameter D₅₀ of the first metal magnetic powder may be in a range from 0.1 μm to 0.2 μm, and the average particle diameter D₅₀ of the second metal magnetic powder may be in a range from 1 μm to 2 μm, and the average particle diameter D₅₀ of the third metal magnetic powder may be in a range from 25 μm to 30 μm.

The magnetic particles may be ferrite particles or metal magnetic particles that exhibit magnetic properties.

The ferrite particles may include, for example, at least one of spinel-type ferrites such as Mg—Zn-based ferrites, Mn—Zn-based ferrites, Mn—Mg-based ferrites, Cu—Zn-based ferrites, Mg—Mn—Sr-based ferrites, and Ni—Zn-based ferrites, hexagonal ferrites such as Ba—Zn-based ferrites, Ba—Mg-based ferrites, Ba—Ni-based ferrites, Ba—Co-based ferrites, and Ba—Ni—Co-based ferrites, garnet-type ferrites such as Y-based ferrites, and Li-based ferrites.

The metal magnetic particles may consist of two or more types of powder particles having different compositions, and may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the metal magnetic particles may be at least one of pure iron, Fe—Si-based alloys, Fe—Si—Al-based alloys, Fe—Ni-based alloys, Fe—Ni—Mo-based alloys, Fe—Ni—Mo—Cu-based alloys, Fe—Co-based alloys, Fe—Ni—Co-based alloys, Fe—Cr-based alloys, Fe—Cr—Si-based alloys, Fe—Si—Cu—Nb-based alloys, Fe—Ni—Cr-based alloys, and Fe—Cr—Al-based alloys. Here, different compositions of metal magnetic particles may also mean different contents.

The metal magnetic particles may be amorphous or crystalline. For example, the metal magnetic particles may be an Fe—Si—B—Cr-based amorphous alloy, but the present embodiment is not limited thereto. The metal magnetic particles may have an average particle diameter in a range from about 0.1 μm to 30 μm, but are not limited thereto. In this specification, an average particle diameter may refer to a particle size distribution expressed as D₉₀, D₅₀, etc. The particle size distribution is well known to those skilled in the art as an indicator of what proportion of particles of what size (particle diameter) are contained within a population of particles to be measured. D₅₀ (a particle diameter corresponding to 50% of a cumulative volume of the particle size distribution) refers to an average particle diameter.

The metal magnetic particles may be two or more types of different metal magnetic particles. Herein, that the types of the metal magnetic particles are different means that the metal magnetic particles are distinguished from each other in at least one of average particle diameter, composition, component ratio, crystallinity, and shape.

The insulating material may include epoxy, polyimide, liquid crystal polymer, etc., either alone or in combination, but is not limited thereto.

The method of forming the magnetic body 100 is not particularly limited. For example, the magnetic body 100 may be formed by placing sheets magnetic material on the upper and lower portions of the first coil 200 and the second coil 300 and compressing and curing the sheets.

The first coil 200 and the second coil 300 are disposed inside the magnetic body 100, exhibiting the characteristics of the coil electronic component. For example, when the coil electronic component 1000 of the present embodiment is utilized as a power inductor, when current is applied to the first coil 200 and the second coil 300, the coil electronic component may serve to stabilize the power source of an electronic device by storing energy in the form of a magnetic field and maintaining the output voltage.

The first coil 200 and the second coil 300 are magnetically coupled to each other, thereby comprising a coupled inductor structure.

The support member 400 is disposed inside the magnetic body 100, and supports the first coil 200 and the second coil 300.

The support member 400 may be made of an insulating material including a thermosetting insulating resin such as epoxy resin, a thermoplastic insulating resin such as polyimide, or a photosensitive insulating resin, or an insulating material impregnated with a reinforcing member such as glass fiber or inorganic filler. For example, the support member 400 may be made of an insulating material such as prepreg, Ajinomoto build-up film (ABF), FR-4, bismaleimide triazine (BT) film, a photo imageable dielectric (PID) film, etc., but the present embodiment is not limited thereto.

Inorganic fillers may include at least one selected from the group consisting of silica (SiO₂), alumina (Al₂O₃), silicon carbide (SiC), barium sulfate (BaSO₄), talc, mud, mica powder, aluminum hydroxide (Al(OH)₃), magnesium hydroxide (Mg(OH)₂), and calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃).

The support member 400 has a first through-hole 410 and a second through-hole 420. The first through-hole 410 and the second through-hole 420 may be filled with a magnetic material that comprises the magnetic body 100, to form a first core 110 and a second core 120, thereby improving the performance of the coil electronic component is.

The support member 400 may have a first support surface 430 and a second support surface 440 facing each other in the thickness direction (T-axis direction).

The first coil 200 may be disposed on the first support surface 430 and the second support surface 440 of the support member 400, and the second coil 300 may be disposed on the first support surface 430 and the second support surface 440 of the support member 400.

The first coil 200 may include a first coil pattern 210, a second coil pattern 220, and a first via 230. The first coil pattern 210 is disposed on the first support surface 430 of the support member 400, and is wound around the first core 110. The second coil pattern 220 is disposed on the second support surface 440 of the support member 400, and is wound around the first core 110. The first via 230 connects the first coil pattern 210 and the second coil pattern 220. In other words, the first coil pattern 210 and the second coil pattern 220 may be electrically connected to each other through the first via 230.

The first coil pattern 210 has a first lead-out portion 213 at an end. The first lead-out portion 213 may be exposed (or extend) from the fourth surface S4 of the magnetic body 100 and be connected to the first external electrode 500. The second coil pattern 220 has a second lead-out portion 223 at an end. The second lead-out portion 223 may be exposed (or extend) from the third surface S3 of the magnetic body 100 and be connected to the second external electrode 600.

Further, when the first coil pattern 210, the first lead-out portion 213, and the first via 230 are formed on the first support surface 430 of the support member 400 by plating, each of the first coil pattern 210, the first lead-out portion 213, and the first via 230 may include a seed layer, such as an electroless plating layer, and an electroplating layer. Herein, the electroplating layer may have a single-layer structure or may have a multi-layer structure. An electroplating layer which has a multi-layer structure may be formed in a conformal film structure in which one electroplating layer covers another electroplating layer, or may be formed in a shape in which an electroplating layer is stacked only on one surface of another electroplating layer. The seed layer of the first coil pattern 210, the seed layer of the first lead-out portion 213, and the seed layer of the first via 230 may be integrally formed such that no boundary is formed therebetween, but the present embodiment is not limited thereto. The electroplating layer of the first coil pattern 210, the electroplating layer of the first lead-out portion 213, and the electroplating layer of the first via 230 may be integrally formed such that no boundary is formed therebetween, but the present embodiment is not limited thereto. This may be equally applied to the second coil pattern 220 and the second lead-out portion 223, and a third coil pattern 310 and a third lead-out portion 313, and a fourth coil pattern 320 and a fourth lead-out portion 323.

Each of the first coil pattern 210, the second coil pattern 220, and the first via 230 may be made of a conductive material such as copper (Cu), aluminum (Al), silver (Ag), tin (Sn), gold (Au), nickel (Ni), lead (Pb), titanium (Ti), or an alloy thereof, but the present embodiment is not limited thereto.

An insulating film IF may be disposed between the first coil pattern 210 and the magnetic body 100 and between the second coil pattern 220 and the magnetic body 100. The insulating film IF may be disposed along the surfaces of the support member 400, the first coil pattern 210, and the second coil pattern 220. No insulating film IF is present where the first coil pattern 210 is connected to the first external electrode 500 and where the second coil pattern 220 is connected to the second external electrode 600. The insulating film IF is for insulating the first coil pattern 210 and the second coil pattern 220 from the magnetic body 100, and may contain a well-known insulating material such as parylene, but is not limited thereto. The insulating film IF may be formed by a method such as vapor deposition, but is not limited thereto. For example, the insulating film IF may be formed by stacking insulating film on both surfaces of the support member 400. This may be equally applied to the third coil pattern 310 and the fourth coil pattern 320.

The second coil 300 may include the third coil pattern 310, the fourth coil pattern 320, and a second via 330. The third coil pattern 310 is disposed on the first support surface 430 of the support member 400, and is wound around the second core 120. The fourth coil pattern 320 is disposed on the second support surface 440 of the support member 400, and is wound around the second core 120. The second via 330 connects the third coil pattern 310 and the fourth coil pattern 320. In other words, the third coil pattern 310 and the fourth coil pattern 320 may be electrically connected to each other through the second via 330.

The third coil pattern 310 has the third lead-out portion 313 at an end. The third lead-out portion 313 may be exposed (or extend) from the third surface S3 of the magnetic body 100 and be connected to the third external electrode 700. The fourth coil pattern 320 has the fourth lead-out portion 323 at an end. The fourth lead-out portion 323 may be exposed (or extend) from the fourth surface S4 of the magnetic body 100 and be connected to the fourth external electrode 800.

Hereinafter, the shapes of the first coil pattern 210, the second coil pattern 220, the third coil pattern 310, and the fourth coil pattern 320 will be described in more detail.

Referring to FIG. 3, the first coil pattern 210 may include a first winding pattern 215 and a first extension pattern 217. The first winding pattern 215 is a portion wound at least once around the first core 110, and the first extension pattern 217 is a portion wound to surround the first core 110 and the second core 120. In other words, the first coil pattern 210 may include the first winding pattern 215 that extends from the first via 230 and is wound clockwise around the first core 110 about 1.75 times, and the first extension pattern 217 that extends from the first winding pattern 215 and is wound clockwise around the first core 110 and the second core 120 about one time. However, the numbers of turns of the first winding pattern 215 and the first extension pattern 217 are not limited thereto, and may be variously changed. At an end of the first extension pattern 217, the first lead-out portion 213 may be disposed.

Referring to FIG. 4, the second coil pattern 220 may include a second winding pattern 225 and a second extension pattern 227. The second winding pattern 225 is a portion wound at least once around the first core 110, and the second extension pattern 227 is a portion wound to surround the first core 110 and the second core 120. In other words, the second coil pattern 220 may include the second winding pattern 225 that extends from the first via 230 and is wound counterclockwise around the first core 110 about 1.75 times, and the second extension pattern 227 that extends from the second winding pattern 225 and is wound counterclockwise around the first core 110 and the second core 120 about one time. However, the numbers of turns of the second winding pattern 225 and the second extension pattern 227 are not limited thereto, and may be variously changed. At an end of the second extension pattern 227, the second lead-out portion 223 may be disposed.

Cross sections of the first coil pattern 210 and the second coil pattern 220 may have various well-known shapes such as rectangular shapes, circular shapes, oval shapes, etc. Here, the cross sections refer to cross sections parallel to the thickness direction (T-axis direction).

Referring to FIG. 3 again, the third coil pattern 310 may include a third winding pattern 315 and a third extension pattern 317. The third winding pattern 315 is a portion wound at least once around the second core 120, and the third extension pattern 317 is a portion wound to surround the first core 110 and the second core 120. In other words, the third coil pattern 310 may include the third winding pattern 315 that extends from the second via 330 and is wound clockwise around the second core 120 about 1.75 times, and the third extension pattern 317 that extends from the third winding pattern 315 and is wound clockwise around the first core 110 and the second core 120 about one time. However, the numbers of turns of the third winding pattern 315 and the third extension pattern 317 are not limited thereto, and may be variously changed. At an end of the third extension pattern 317, the third lead-out portion 313 may be disposed.

Referring to FIG. 4 again, the fourth coil pattern 320 may include a fourth winding pattern 325 and a fourth extension pattern 327. The fourth winding pattern 325 is a portion wound at least once around the second core 120, and the fourth extension pattern 327 is a portion wound to surround the first core 110 and the second core 120. In other words, the fourth coil pattern 320 may include the fourth winding pattern 325 that extends from the second via 330 and is wound counterclockwise around the second core 120 about 1.75 times, and the fourth extension pattern 327 that extends from the fourth winding pattern 325 and is wound counterclockwise around the first core 110 and the second core 120 about one time. However, the numbers of turns of the fourth winding pattern 325 and the fourth extension pattern 327 are not limited thereto, and may be variously changed. At an end of the fourth extension pattern 327, the fourth lead-out portion 323 may be disposed.

Cross sections of the third coil pattern 310 and the fourth coil pattern 320 may have various well-known shapes such as rectangular shapes, circular shapes, oval shapes, etc. Here, the cross sections refer to cross sections parallel to the thickness direction (T-axis direction).

The first external electrode 500 and the second external electrode 600 are disposed outside the magnetic body 100, and are electrically connected to the first coil 200.

The first external electrode 500 may include a first electrode pad 510 and a first connection portion 520.

The first electrode pad 510 is disposed on the sixth surface S6 of the magnetic body 100, and the first connection portion 520 extends from the first electrode pad 510 to the fourth surface S4 of the magnetic body 100. The first lead-out portion 213 of the first coil 200 is exposed (or extend) from the fourth surface S4 of the magnetic body 100 and is connected to the first connection portion 520. Accordingly, the first coil 200 is electrically connected to the first external electrode 500. Further, the first electrode pad 510 and the first connection portion 520 may be an integral structure.

The second external electrode 600 may include a second electrode pad 610 and a second connection portion 620.

The second electrode pad 610 is disposed on the sixth surface S6 of the magnetic body 100, and the second connection portion 620 extends from the second electrode pad 610 to the third surface S3 of the magnetic body 100. The second lead-out portion 223 of the first coil 200 is exposed (or extend) from the third surface S3 of the magnetic body 100 and is connected to the second connection portion 620. Accordingly, the first coil 200 is electrically connected to the second external electrode 600. Further, the second electrode pad 610 and the second connection portion 620 may be an integral structure.

Even if the length of the first coil 200 is constant, the lengths of the first connection portion 520 of the first external electrode 500 and the second connection portion 620 of the second external electrode 600 may differ depending on the structure of the magnetic body 100. In particular, as the lengths of the first connection portion 520 of the first external electrode 500 and the second connection portion 620 of the second external electrode 600 increase, the DC resistance Rdc of the first coil 200 may increase.

According to the present embodiment, it is possible to change the structure of the magnetic body 100 such that the lengths of the first connection portion 520 and the second connection portion 620 decrease, thereby reducing the DC resistance Rdc of the first coil 200.

Referring to FIG. 5, a first distance D1 from the first coil 200 and the second coil 300 to the fifth surface S5 of the magnetic body 100 may be larger than a second distance D2 from the first coil 200 and the second coil 300 to the sixth surface S6 of the magnetic body 100. According to the present embodiment, as compared to the case where the first distance D1 and the second distance D2 are the same, the second distance D2 is smaller, so the lengths of the first connection portion 520 of the first external electrode 500 and the second connection portion 620 of the second external electrode 600 decrease as much as the decrease in the second distance. Accordingly, the DC resistance Rdc of the first coil 200 may decrease.

Here, the first distance D1 and the second distance D2 are measured based on a scanning electron microscope (SEM) photograph of a cross section (hereinafter, referred to as the “L-T cross section”) taken in the length direction (L-axis direction) and the thickness direction (T-axis direction) and perpendicular to the width direction (W-axis direction) at a central portion of the coil electronic component 1000 in the width direction (W-axis direction). The first distance D1 may be the arithmetic average of the distances from the fifth surface S5 of the magnetic body 100 to three equally-spaced points on the outer surface of each turn of the first coil pattern 210 and the third coil pattern 310 in the thickness direction (T-axis direction), shown in the above-mentioned L-T cross section photograph. The second distance D2 may be the arithmetic average of the distances from the sixth surface S6 of the magnetic body 100 to three equally-spaced points on the outer surface of each turn of the second coil pattern 220 and the fourth coil pattern 320 in the thickness direction (T-axis direction), shown in the above-mentioned L-T cross section photograph. Other methods and/or tools appreciated by one of ordinary skill in the art, even if not described in the present disclosure, may also be used.

Further, the difference between the first distance D1 and the second distance D2 may be in a range from 5 μm to 160 μm.

If the difference between the first distance D1 and the second distance D2 is smaller than 5 μm, the DC resistance reduction effect may not be significant. If the difference between the first distance D1 and the second distance D2 exceeds 160 μm, the amount by which the inductance is reduced may be greater than the amount by which the DC resistance is reduced, and thus the overall characteristics of the coil electronic component may be degraded.

In other words, according to the present embodiment, in the magnetic body 100, the thickness T1 of an upper cover layer 130 may be larger than the thickness T2 of a lower cover layer 140. Here, the upper cover layer 130 is a region between the fifth surface S5 of the magnetic body 100, and the first coil 200 and the second coil 300, and the lower cover layer 140 is a region between the sixth surface S6 of the magnetic body 100, and the first coil 200 and the second coil 300. In the present embodiment, it is possible to increase the thickness T1 of the upper cover layer 130 and decrease the thickness T2 of the lower cover layer 140 with the volume of the magnetic body 100 constant. Accordingly, the lengths of the first connection portion 520 of the first external electrode 500 and the second connection portion 620 of the second external electrode 600 may decrease, thereby reducing the DC resistance Rdc of the first coil 200. A difference between the thickness of the upper cover layer 130 and the thickness of the lower cover layer 140 may be in a range of from 5 μm to 160 μm. In some embodiments, D1 and T1 may be used interchangeably, and T1 may be measured according to the measuring method for D1. In some embodiments, D2 and T2 may be used interchangeably, and T2 may be measured according to the measuring method for D2. Other methods and/or tools appreciated by one of ordinary skill in the art, even if not described in the present disclosure, may also be used.

Furthermore, the first external electrode 500 and the second external electrode 600 may each be made of a conductive material such as copper (Cu), aluminum (Al), silver (Ag), tin (Sn), gold (Au), nickel (Ni), lead (Pb), chromium (Cr), titanium (Ti), or an alloy thereof, but is not limited thereto.

The first external electrode 500 and the second external electrode 600 may include a plurality of metal layers formed by plating a conductive metal.

Referring to the right circle in FIG. 1, the first external electrode 500 may include a first metal layer 501, a second metal layer 502, and a third metal layer 503.

The first metal layer 501 may be a plating layer that is in contact with the first lead-out portion 213 of the first coil 200 and the outer surface of the magnetic body 100, and contain copper (Cu). The second metal layer 502 may be a plating layer that covers the first metal layer 501, and contain nickel (Ni). The third metal layer 503 may be a plating layer that covers the second metal layer 502, and contain tin (Sn). However, the present embodiment is not limited to such a three-layer structure, and a two-layer structure in which only one plating layer is added on the first metal layer 501 is possible.

Referring to the left circle in FIG. 1, the second external electrode 600 may include a first metal layer 601, a second metal layer 602, and a third metal layer 603.

The first metal layer 601 may be a plating layer that is in contact with the second lead-out portion 223 of the first coil 200 and the outer surface of the magnetic body 100, and contain copper (Cu). The second metal layer 602 may be a plating layer that covers the first metal layer 601, and contain nickel (Ni). The third metal layer 603 may be a plating layer that covers the second metal layer 602, and contain tin (Sn). However, the present embodiment is not limited to such a three-layer structure, and a two-layer structure in which only one plating layer is added on the first metal layer 601 is possible.

As described above, the first external electrode 500 and the second external electrode 600 may each contain nickel (Ni), copper (Cu), palladium (Pd), gold (Au), or an alloy thereof, and include a plurality of plating layers. For example, the first external electrode 500 and the second external electrode 600 may each be made of combinations such as nickel (Ni) layer, copper (Cu) layer, nickel/copper (Ni/Cu) layer, palladium/nickel (Pd/Ni) layer, palladium/nickel/copper (Pd/Ni/Cu) layer, and copper/nickel/copper (Cu/Ni/Cu) layer.

In some embodiments, the outermost layer may be made of tin (Sn). Since the tin plating layer has a relatively low melting point, it can improve the ease of substrate mounting of the first external electrode 500 and the second external electrode 600.

In general, the tin plating layer may be bonded to electrode pads on a substrate through a solder containing tin (Sn)-copper (Cu)-silver (Ag) alloy paste. In other words, the tin plating layer may melt and bond with the solder during a heat treatment (reflow) process.

The third external electrode 700 and the fourth external electrode 800 are disposed outside the magnetic body 100, and are electrically connected to the second coil 300.

The third external electrode 700 may include a third electrode pad 710 and a third connection portion 720.

The third electrode pad 710 is disposed on the sixth surface S6 of the magnetic body 100, and the third connection portion 720 extends from the third electrode pad 710 to the third surface S3 of the magnetic body 100. The third lead-out portion 313 of the second coil 300 is exposed (or extend) from the third surface S3 of the magnetic body 100 and is connected to the third connection portion 720. Accordingly, the second coil 300 is electrically connected to the third external electrode 700. Further, the third electrode pad 710 and the third connection portion 720 may be an integral structure.

The fourth external electrode 800 may include a fourth electrode pad 810 and a fourth connection portion 820.

The fourth electrode pad 810 is disposed on the sixth surface S6 of the magnetic body 100, and the fourth connection portion 820 extends from the fourth electrode pad 810 to the fourth surface S4 of the magnetic body 100. The fourth lead-out portion 323 of the second coil 300 is exposed (or extend) from the fourth surface S4 of the magnetic body 100 and is connected to the fourth connection portion 820. Accordingly, the second coil 300 is electrically connected to the fourth external electrode 800. Further, the fourth electrode pad 810 and the fourth connection portion 820 may be an integral structure.

The structures and components of the third external electrode 700 and the fourth external electrode 800 are the same as those of the first external electrode 500 and the second external electrode 600 described above, so a redundant description thereof will be omitted.

Further, an insulating layer 900 may be disposed on the magnetic body 100 of the coil electronic component 1000 according to the present embodiment, except for the area where the first external electrode 500, the second external electrode 600, the third external electrode 700, and the fourth external electrode 800 are disposed. However, the insulating layer may be present between the portion where the first lead-out portion 213 of the first coil 200 is exposed and the portion where the fourth lead-out portion 323 of the second coil 300 is exposed on the fourth surface S4 of the magnetic body 100, and the insulating layer may be present between the portion where the second lead-out portion 223 of the first coil 200 is exposed and the portion where the third lead-out portion 313 of the second coil 300 is exposed on the third surface S3 of the magnetic body 100. In this case, the first connection portion 520 of the first external electrode 500, the second connection portion 620 of the second external electrode 600, the third connection portion 720 of the third external electrode 700, and the fourth connection portion 820 of the fourth external electrode 800 may cover portions of the insulating layer.

As described above, the insulating layer 900 may be disposed on at least a portion of the first surface S1, second surface S2, third surface S3, fourth surface S4, fifth surface S5, and sixth surface S6 of the magnetic body 100 to prevent electrical short circuit between other electronic components and the first, second, third, and fourth external electrodes 500, 600, 700, and 800.

The insulating layer 900 may be utilized as a resist when forming the first, second, third, and fourth external electrodes 500, 600, 700, and 800 by electroplating, but is not limited thereto.

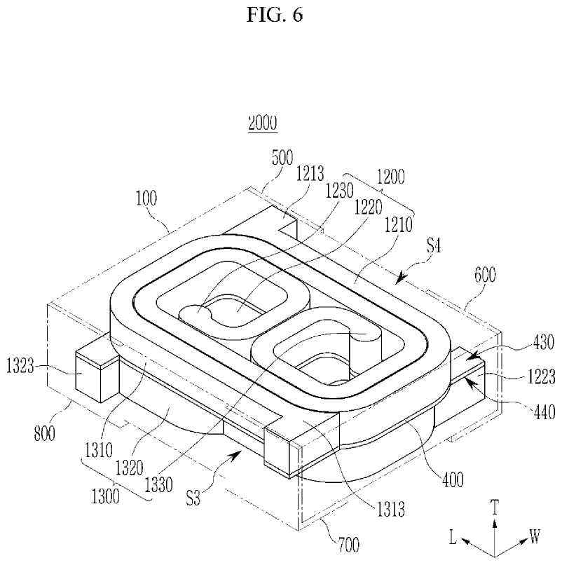

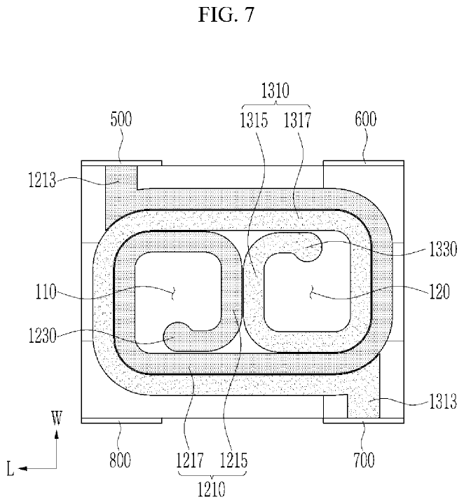

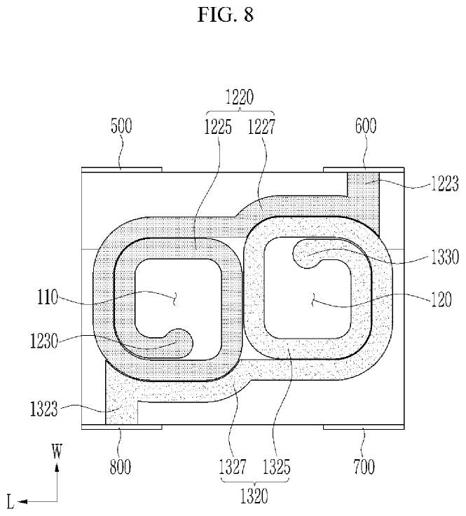

FIG. 6 is a view schematically illustrating a coil electronic component according to another embodiment, and FIG. 7 is a view schematically illustrating a first coil pattern and a third coil pattern shown in FIG. 6, and FIG. 8 is a view schematically illustrating a second coil pattern and a fourth coil pattern shown in FIG. 6.

Referring to FIG. 6, FIG. 7, and FIG. 8, a coil electronic component 2000 according to another embodiment includes a magnetic body 100, a first coil 1200, a second coil 1300, a support member 400, a first external electrode 500, a second external electrode 600, a third external electrode 700, and a fourth external electrode 800.

The first coil 1200 may be disposed on a first support surface 430 and a second support surface 440 of the support member 400, and the second coil 1300 may be disposed on the first support surface 430 and the second support surface 440 of the support member 400.

The first coil 1200 may include a first coil pattern 1210, a second coil pattern 1220, and a first via 1230. The first coil pattern 1210 is disposed on the first support surface 430 of the support member 400, and is wound around a first core 110. The second coil pattern 1220 is disposed on the second support surface 440 of the support member 400, and is wound around the first core 110. The first via 1230 connects the first coil pattern 1210 and the second coil pattern 1220. In other words, the first coil pattern 1210 and the second coil pattern 1220 may be electrically connected to each other through the first via 1230.

The first coil pattern 1210 has a first lead-out portion 1213 at an end. The first lead-out portion 1213 may be exposed (or extend) from the fourth surface S4 of the magnetic body 100 and be connected to the first external electrode 500. The second coil pattern 1220 has a second lead-out portion 1223 at an end. The second lead-out portion 1223 may be exposed (or extend) from the fourth surface S4 of the magnetic body 100 and is connected to the second external electrode 600.

The second coil 1300 may include a third coil pattern 1310, a fourth coil pattern 1320, and a second via 1330. The third coil pattern 1310 is disposed on the first support surface 430 of the support member 400, and is wound around the second core 120. The fourth coil pattern 1320 is disposed on the second support surface 440 of the support member 400, and is wound around the second core 120. The second via 1330 connects the third coil pattern 1310 and the fourth coil pattern 1320. In other words, the third coil pattern 1310 and the fourth coil pattern 1320 may be electrically connected to each other through the second via 1330.

The third coil pattern 1310 has a third lead-out portion 1313 at an end. The third lead-out portion 1313 may be exposed (or extend) from the third surface S3 of the magnetic body 100 and be connected to the third external electrode 700. The fourth coil pattern 1320 has a fourth lead-out portion 1323 at an end. The fourth lead-out portion 1323 may be exposed (or extend) from the third surface S3 of the magnetic body 100 and be connected to the fourth external electrode 800.

Hereinafter, the shapes of the first coil pattern 1210, the second coil pattern 1220, the third coil pattern 1310, and the fourth coil pattern 1320 will be described in more detail.

Referring to FIG. 7, the first coil pattern 1210 may include a first winding pattern 1215 and a first extension pattern 1217. In other words, the first coil pattern 1210 may include the first winding pattern 1215 that extends from the first via 1230 and is wound counterclockwise around the first core 110 about one time, and the first extension pattern 1217 that extends from the first winding pattern 1215 and is wound counterclockwise around the first core 110 and the second core 120 about 0.75 times. However, the numbers of turns of the first winding pattern 1215 and the first extension pattern 1217 are not limited thereto, and may be variously changed. At an end of the first extension pattern 1217, the first lead-out portion 1213 may be disposed.

Referring to FIG. 8, the second coil pattern 1220 may include a second winding pattern 1225 and a second extension pattern 1227. The second coil pattern 1220 may include the second winding pattern 1225 that extends from the first via 1230 and is wound clockwise around the first core 110 about 1.5 times, and the second extension pattern 1227 that extends from the second winding pattern 1225 toward the second core 120. However, the numbers of turns of the second winding pattern 1225 and the second extension pattern 1227 are not limited thereto, and may be variously changed. At an end of the second extension pattern 1227, the second lead-out portion 1223 may be disposed.

Referring to FIG. 7 again, the third coil pattern 1310 may include a third winding pattern 1315 and a third extension pattern 1317. The third coil pattern 1310 may include the third winding pattern 1315 that extends from the second via 1330 and is wound counterclockwise around the second core 120 about one time, and the third extension pattern 1317 that extends from the third winding pattern 1315 and is wound counterclockwise around the first core 110 and the second core 120 about 0.75 times. However, the numbers of turns of the third winding pattern 1315 and the third extension pattern 1317 are not limited thereto, and may be variously changed. At an end of the third extension pattern 1317, the third lead-out portion 1313 may be disposed.

Referring to FIG. 8 again, the fourth coil pattern 1320 may include a fourth winding pattern 1325 and a fourth extension pattern 1327. The fourth coil pattern 1320 may include the fourth winding pattern 1325 that extends from the second via 1330 and is wound clockwise around the second core 120 about 1.5 times, and the fourth extension pattern 1327 that extends from the fourth winding pattern 1325 toward the first core 110. However, the numbers of turns of the fourth winding pattern 1325 and the fourth extension pattern 1327 are not limited thereto, and may be variously changed. At an end of the fourth extension pattern 1327, the fourth lead-out portion 1323 may be disposed.

The constituent elements other than the above-mentioned constituent elements are identical to those in the coil electronic component shown in FIG. 1, and thus a redundant description thereof will be omitted.

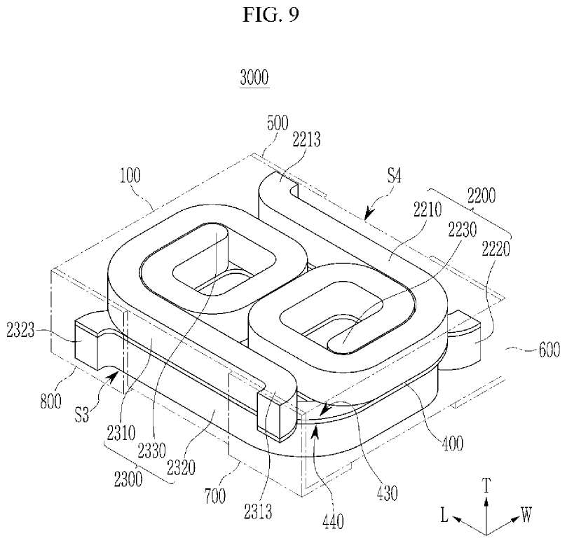

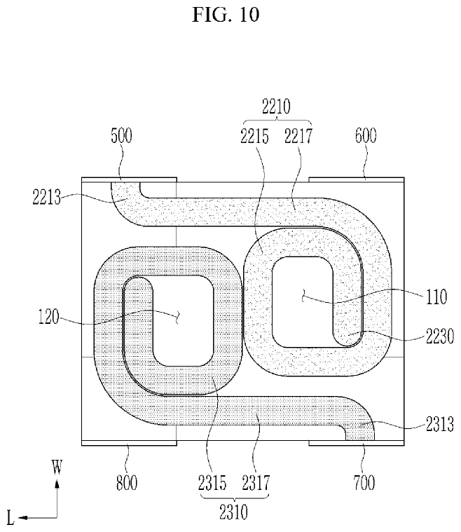

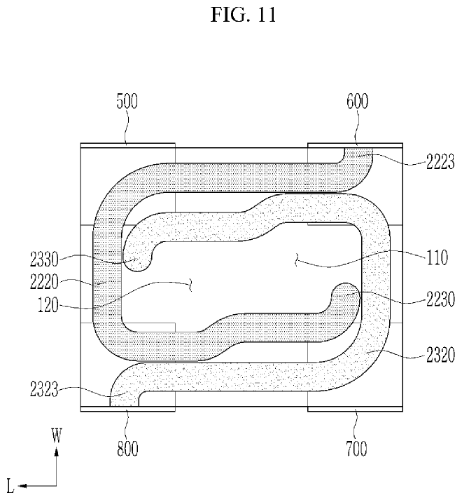

FIG. 9 is a cross-sectional view schematically illustrating a coil electronic component according to another embodiment, and FIG. 10 is a view schematically illustrating a first coil pattern and a third coil pattern shown in FIG. 9, and FIG. 11 is a view schematically illustrating a second coil pattern and a fourth coil pattern shown in FIG. 9.

Referring to FIG. 9, FIG. 10, and FIG. 11, a coil electronic component 3000 according to another embodiment includes a magnetic body 100, a first coil 2200, a second coil 2300, a support member 400, a first external electrode 500, a second external electrode 600, a third external electrode 700, and a fourth external electrode 800.

The first coil 2200 may be disposed on a first support surface 430 and a second support surface 440 of the support member 400, and the second coil 2300 may be disposed on the first support surface 430 and the second support surface 440 of the support member 400.

The first coil 2200 may include a first coil pattern 2210, a second coil pattern 2220, and a first via 2230. The first coil pattern 2210 is disposed on the first support surface 430 of the support member 400, and is wound around a first core 110. The second coil pattern 2220 is disposed on the second support surface 440 of the support member 400, and is wound around the first core 110 and the second core 120. The first via 2230 connects the first coil pattern 2210 and the second coil pattern 2220. In other words, the first coil pattern 2210 and the second coil pattern 2220 may be electrically connected to each other through the first via 2230.

The first coil pattern 2210 has a first lead-out portion 2213 at an end. The first lead-out portion 2213 may be exposed (or extend) from the fourth surface S4 of the magnetic body 100 and be connected to the first external electrode 500. The second coil pattern 2220 has a second lead-out portion 2223 at an end. The second lead-out portion 2223 may be exposed (or extend) from the fourth surface S4 of the magnetic body 100 and is connected to the second external electrode 600.

The second coil 2300 may include a third coil pattern 2310, a fourth coil pattern 2320, and a second via 2330. The third coil pattern 2310 is disposed on the first support surface 430 of the support member 400, and is wound around the second core 120. The fourth coil pattern 2320 is disposed on the second support surface 440 of the support member 400, and is wound around the first core 110 and the second core 120. The second via 2330 connects the third coil pattern 2310 and the fourth coil pattern 2320. In other words, the third coil pattern 2310 and the fourth coil pattern 2320 may be electrically connected to each other through the second via 2330.

The third coil pattern 2310 has a third lead-out portion 2313 at an end. The third lead-out portion 2313 may be exposed (or extend) from the third surface S3 of the magnetic body 100 and be connected to the third external electrode 700. The fourth coil pattern 2320 has a fourth lead-out portion 2323 at an end. The fourth lead-out portion 2323 may be exposed (or extend) from the third surface S3 of the magnetic body 100 and be connected to the fourth external electrode 800.

Hereinafter, the shapes of the first coil pattern 2210, the second coil pattern 2220, the third coil pattern 2310, and the fourth coil pattern 2320 will be described in more detail.

Referring to FIG. 10, the first coil pattern 2210 may include a first winding pattern 2215 and a first extension pattern 2217. The first coil pattern 2210 may include the first winding pattern 2215 that extends from the first via 2230 and is wound counterclockwise around the first core 110 about 1.25 times, and the first extension pattern 2217 that extends from the first winding pattern 2215 toward the second core 120. However, the numbers of turns of the first winding pattern 2215 and the first extension pattern 2217 are not limited thereto, and may be variously changed. At an end of the first extension pattern 2217, the first lead-out portion 2213 may be disposed.

Referring to FIG. 11, the second coil pattern 2220 may extend from the first via 2230, and be wound clockwise around the first core 110 and the second core 120 about 0.75 times. However, the number of turns of the second coil pattern 2220 is not limited thereto, and may be variously changed. At an end of the second coil pattern 2220, the second lead-out portion 2223 may be disposed.

Referring to FIG. 10 again, the third coil pattern 2310 may include a third winding pattern 2315 and a third extension pattern 2317. The third coil pattern 2310 may include the third winding pattern 2315 that extends from the second via 2330 and is wound counterclockwise around the second core 120 about 1.25 times, and the third extension pattern 2317 that extends from the third winding pattern 2315 toward the first core 110. However, the numbers of turns of the third winding pattern 2315 and the third extension pattern 2317 are not limited thereto, and may be variously changed. At an end of the third extension pattern 2317, the third lead-out portion 2313 may be disposed.

Referring to FIG. 11 again, the fourth coil pattern 2320 may extend from the second via 2330, and be wound clockwise around the first core 110 and the second core 120 about 0.75 times. However, the number of turns of the fourth coil pattern 2320 is not limited thereto, and may be variously changed. At an end of the fourth coil pattern 2320, the fourth lead-out portion 2323 may be disposed.

The constituent elements other than the above-mentioned constituent elements are identical to those in the coil electronic component shown in FIG. 1, and thus a redundant description thereof will be omitted.

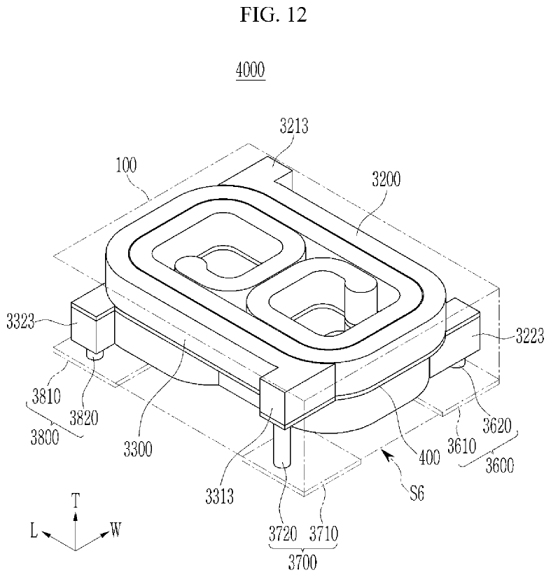

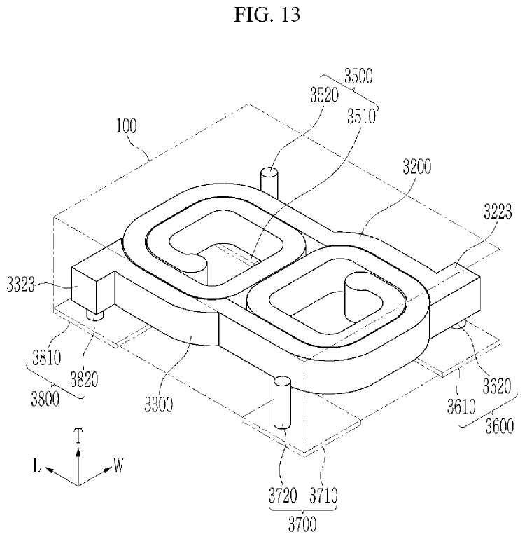

FIG. 12 is a view schematically illustrating a coil electronic component according to another embodiment, and FIG. 13 is a view schematically illustrating some constituent elements of the coil electronic component of FIG. 12.

Referring to FIG. 12 and FIG. 13, a coil electronic component 4000 according to another embodiment includes a magnetic body 100, a first coil 3200, a second coil 3300, a support member 400, a first external electrode 3500, a second external electrode 3600, a third external electrode 3700, and a fourth external electrode 3800. Among the constituent elements of the coil electronic component 4000 according to the present embodiment, constituent elements other than the structure in which the first external electrode 3500 and the second external electrode 3600 are connected to the first coil 3200 and the structure in which the third external electrode 3700 and the fourth external electrode 3800 are connected to the second coil 3300 are identical to those in the coil electronic component shown in FIG. 6, and thus a redundant description thereof will be omitted.

The first external electrode 3500 may include a first electrode pad 3510 and a first connection electrode 3520.

The first electrode pad 3510 is disposed on the sixth surface S6 of the magnetic body 100, and the first connection electrode 3520 extends from the first electrode pad 3510 and is connected to a first lead-out portion 3213 of the first coil 3200 in the magnetic body 100. Accordingly, the first coil 3200 is electrically connected to the first external electrode 3500. The first connection electrode 3520 may be made of, for example, copper (Cu), but is not limited thereto.

The second external electrode 3600 may include a second electrode pad 3610 and a second connection electrode 3620.

The second electrode pad 3610 is disposed on the sixth surface S6 of the magnetic body 100, and the second connection electrode 3620 extends from the second electrode pad 3610 and is connected to a second lead-out portion 3223 of the first coil 3200 in the magnetic body 100. Accordingly, the first coil 3200 is electrically connected to the second external electrode 3600. The second connection electrode 3620 may be made of, for example, copper (Cu), but is not limited thereto.

The third external electrode 3700 may include a third electrode pad 3710 and a third connection electrode 3720, and the third connection electrode 3720 connects the third electrode pad 3710 and a third lead-out portion 3313 of the second coil 3300 together in the magnetic body 100. Accordingly, the second coil 3300 is electrically connected to the third external electrode 3700. Further, the fourth external electrode 3800 may include a fourth electrode pad 3810 and a fourth connection electrode 3820, and the fourth connection electrode 3820 connects the fourth electrode pad 3810 and a fourth lead-out portion 3323 of the second coil 3300 together in the magnetic body 100. Accordingly, the second coil 3300 is electrically connected to the fourth external electrode 3800. The third external electrode 3700 and the fourth external electrode 3800 may each be made of, for example, copper (Cu), but is not limited thereto.

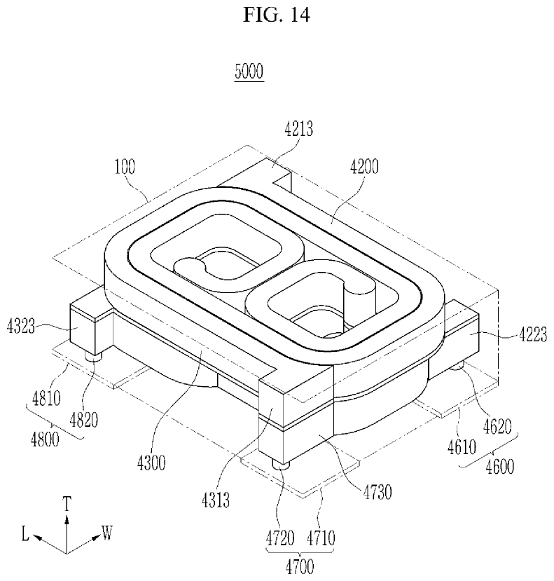

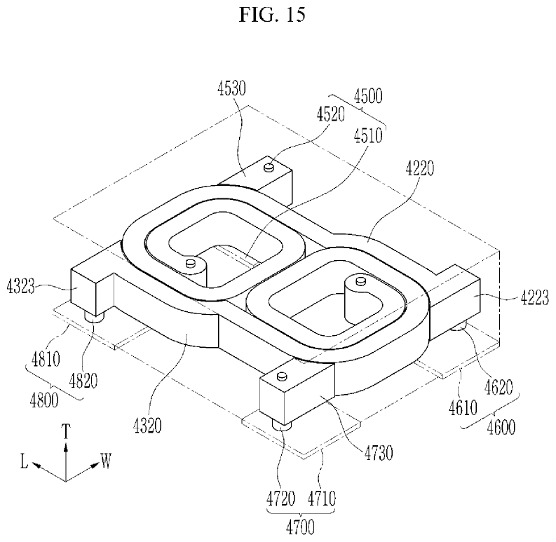

FIG. 14 is a view schematically illustrating a coil electronic component according to another embodiment, and FIG. 15 is a view schematically illustrating some constituent elements of the coil electronic component of FIG. 14.

Referring to FIG. 14 and FIG. 15, a coil electronic component 5000 according to another embodiment includes a magnetic body 100, a first coil 4200, a second coil 4300, a support member 400, a first external electrode 4500, a second external electrode 4600, a third external electrode 4700, a fourth external electrode 4800, a first dummy pad 4530, and a second dummy pad 4730. Among the constituent elements of the coil electronic component 5000 according to the present embodiment, constituent elements other than the first dummy pad 4530 and the second dummy pad 4730 are identical to those in the coil electronic component shown in FIG. 12, and thus a redundant description thereof will be omitted.

The first dummy pad 4530 is disposed inside the magnetic body 100, and a first connection electrode 4520 of the first external electrode 4500 passes through the first dummy pad 4530. For example, the first dummy pad 4530 may be disposed between a first electrode pad 4510 and a first lead-out portion 4213 of the first coil 4200, and be spaced apart from a second coil pattern 4220.

The second dummy pad 4730 is disposed inside the magnetic body 100, and a third connection electrode 4720 of the third external electrode 4700 passes through the second dummy pad 4730. For example, the second dummy pad 4730 may be disposed between a third electrode pad 4710 and a third lead-out portion 4313 of the second coil 4300, and be spaced apart from a fourth coil pattern 4320.

The constituent elements other than the above-mentioned constituent elements are identical to those in the coil electronic component shown in FIG. 12, and thus a redundant description thereof will be omitted.

Hereinafter, specific embodiments of the present disclosure will be presented. However, the following embodiments are intended only to illustrate or describe the disclosure and should not be construed as liming the scope of the disclosure.

### Manufacturing Example: Manufacture of Coil Electronic Component

### Example 1

Coil electronic components are manufactured such that the thicknesses of upper cover layers are 177 μm and the thicknesses of lower cover layers are 172 μm.

### Example 2

Coil electronic components are manufactured such that the thicknesses of upper cover layers are 179.5 μm and the thicknesses of lower cover layers are 169.5 μm.

### Example 3

Coil electronic components are manufactured such that the thicknesses of upper cover layers are 184.5 μm and the thicknesses of lower cover layers are 164.5 μm.

### Example 4

Coil electronic components are manufactured such that the thicknesses of upper cover layers are 194.5 μm and the thicknesses of lower cover layers are 154.5 μm.

### Example 5

Coil electronic components are manufactured such that the thicknesses of upper cover layers are 214.5 μm and the thicknesses of lower cover layers are 134.5 μm.

### Example 6

Coil electronic components are manufactured such that the thicknesses of upper cover layers are 234.5 μm and the thicknesses of lower cover layers are 114.5 μm.

### Example 7

Coil electronic components are manufactured such that the thicknesses of upper cover layers are 254.5 μm and the thicknesses of lower cover layers are 94.5 μm.

### Comparative Example 1

Coil electronic components are manufactured such that the thicknesses of upper cover layers are 174.5 μm and the thicknesses of lower cover layers are 174.5 μm.

### Comparative Example 2

Coil electronic components are manufactured such that the thicknesses of upper cover layers are 274.5 μm and the thicknesses of lower cover layers are 74.5 μm.

### Comparative Example 3

Coil electronic components are manufactured such that the thicknesses of upper cover layers are 294.5 μm and the thicknesses of lower cover layers are 54.5 μm.

### Experimental Example: Performance of Coil Electronic Component

After manufacturing 30 pieces of each of coil electronic components according to Examples 1 to 7 and Comparative Examples 1 to 3, the thicknesses T1 of the upper cover layers, the thicknesses T2 of the lower cover layers, the inductance L1 of the first coils, the inductance L2 of the second coils, the DC resistance Rdc1 of the first coils, the DC resistance Rdc2 of the second coils, and the coupling coefficients k were measured, and the results are summarized in Table 1 and Table 2.

TABLE 1

| | T1 | T2 | T1 − T2 | L1 | L2 | Rdc1 | Rdc2 | |
|---|---|---|---|---|---|---|---|---|
| | (μm) | (μm) | (μm) | (nH) | (nH) | (mOhm) | (mOhm) | k |
| Comparative | 174.5 | 174.5 | 0 | 49.478 | 49.484 | 4.895 | 4.895 | −0.51402 |
| Example 1 | | | | | | | | |
| Example 1 | 177 | 172 | 5 | 49.473 | 49.481 | 4.886 | 4.885 | −0.51366 |
| Example 2 | 179.5 | 169.5 | 10 | 49.472 | 49.473 | 4.878 | 4.877 | −0.5133 |
| Example 3 | 184.5 | 164.5 | 20 | 49.438 | 49.439 | 4.859 | 4.859 | −0.51251 |
| Example 4 | 194.5 | 154.5 | 40 | 49.295 | 49.298 | 4.823 | 4.824 | −0.51071 |
| Example 5 | 214.5 | 134.5 | 80 | 48.812 | 48.81 | 4.751 | 4.752 | −0.50586 |
| Example 6 | 234.5 | 114.5 | 120 | 47.975 | 47.974 | 4.679 | 4.68 | −0.49892 |
| Example 7 | 254.5 | 94.5 | 160 | 46.684 | 46.682 | 4.607 | 4.607 | −0.4891 |
| Comparative | 274.5 | 74.5 | 200 | 44.804 | 44.802 | 4.534 | 4.533 | −0.4747 |
| Example 2 | | | | | | | | |
| Comparative | 294.5 | 54.5 | 240 | 42.052 | 42.05 | 4.458 | 4.457 | −0.45227 |
| Example 3 | | | | | | | | |

TABLE 2

| | | | Rate of | | Rate of |
|---|---|---|---|---|---|
| | | | Decrease | | Decrease |
| | T1-T2 | L1 | in | Rdc1 | in Rdc1 |
| | (μm) | (nH) | L1 (%) | (mOhm) | (%) |
| Comparative | 0 | 49.478 | — | 4.895 | — |
| Example 1 | | | | | |
| Example 1 | 5 | 49.473 | 0.01% | 4.886 | 0.18% |
| Example 2 | 10 | 49.472 | 0.01% | 4.878 | 0.35% |
| Example 3 | 20 | 49.438 | 0.08% | 4.859 | 0.73% |
| Example 4 | 40 | 49.295 | 0.37% | 4.823 | 1.47% |
| Example 5 | 80 | 48.812 | 1.35% | 4.751 | 2.94% |
| Example 6 | 120 | 47.975 | 3.04% | 4.679 | 4.4% |
| Example 7 | 160 | 46.684 | 5.64% | 4.607 | 5.71% |
| Comparative | 200 | 44.804 | 9.44% | 4.534 | 7.05% |
| Example 2 | | | | | |
| Comparative | 240 | 42.052 | 14.94% | 4.458 | 8.25% |
| Example 3 | | | | | |

Referring to Table 1 and Table 2, in the coil electronic components manufactured according to Examples 1 to 7, the rate of decrease in inductance of the first coils was in a range from 0.01% to 5.64%, and the rate of decrease in DC resistance was in a range from 0.18% to 5.71%. In other words, when the difference in thickness between the upper cover layer and the lower cover layer was in a range from 5 μm to 160 μm, the amount by which the DC resistance decrease was greater than the amount by which the inductance of the first coil decrease, improving the overall characteristics of the coil electronic component.

Meanwhile, in the coil electronic components manufactured according to Comparative Examples 2 and 3, the rate of decrease in inductance of the first coils was in a range from 9.44% to 14.94%, and the rate of decrease in DC resistance was in a range from 7.05% to 8.25%. In other words, when the difference in thickness between the upper cover layer and the lower cover layer exceeded 160 μm, the amount by which the inductance of the first coil decrease was greater than the amount by which the DC resistance decrease, degrading the overall characteristics of the coil electronic component. This is because the thickness of the lower cover layer was too small as compared to the thickness of the upper cover layer.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

What is claimed is:

1. A coil electronic component comprising:
a magnetic body that has a first surface and a second surface facing each other and including a first core and a second core spaced apart from the first core;
a first coil embedded in the magnetic body and wound around the first core;
a second coil embedded in the magnetic body and wound around the second core;
a first external electrode and a second external electrode disposed on the second surface of the magnetic body and connected to the first coil; and
a third external electrode and a fourth external electrode disposed on the second surface of the magnetic body and connected to the second coil,
wherein a first distance from the first coil and the second coil to the first surface is larger than a second distance from the first coil and the second coil to the second surface.

2. The coil electronic component of claim 1, wherein
a difference between the first distance and the second distance is in a range from 5 μm to 160 μm.

3. The coil electronic component of claim 1, further comprising:
a support member that has a first support surface facing the first surface of the magnetic body and a second support surface facing the second surface of the magnetic body,
wherein the first coil includes a first coil pattern that is disposed on the first support surface of the support member, a second coil pattern that is disposed on the second support surface of the support member, and a first via that passes through the support member and connects the first coil pattern and the second coil pattern, and
the second coil includes a third coil pattern that is disposed on the first support surface of the support member, a fourth coil pattern that is disposed on the second support surface of the support member, and a second via that passes through the support member and connects the third coil pattern and the fourth coil pattern.

4. The coil electronic component of claim 3, wherein
the first coil pattern includes a first winding pattern wound around the first core, and a first extension pattern wound to surround the first core and the second core, and
the second coil pattern includes a second winding pattern wound around the first core, and a second extension pattern wound to surround the first core and the second core, and
the third coil pattern includes a third winding pattern wound around the second core, and a third extension pattern wound to surround the first core and the second core, and
the fourth coil pattern includes a fourth winding pattern wound around the second core, and a fourth extension pattern wound to surround the first core and the second core.

5. The coil electronic component of claim 4, wherein
a winding direction of the first winding pattern and a winding direction of the second winding pattern are opposite to each other, and
a winding direction of the third winding pattern and a winding direction of the fourth winding pattern are opposite to each other.

6. The coil electronic component of claim 5, wherein
the winding direction of the first winding pattern and the winding direction of the third winding pattern are the same as each other, and
the winding direction of the second winding pattern and the winding direction of the fourth winding pattern are the same as each other.

7. The coil electronic component of claim 6, wherein
the winding direction of the first winding pattern and a winding direction of the first extension pattern are the same as each other, and
the winding direction of the second winding pattern and a winding direction of the second extension pattern are the same as each other.

8. The coil electronic component of claim 7, wherein
the winding direction of the third winding pattern and a winding direction of the third extension pattern are the same as each other, and
the winding direction of the fourth winding pattern and a winding direction of the fourth extension pattern are the same as each other.

9. The coil electronic component of claim 3, wherein
the first coil pattern includes a first winding pattern wound around the first core, and a first extension pattern wound to surround the first core and the second core, and
the second coil pattern includes a second winding pattern wound around the first core, and a second extension pattern that extends from the second winding pattern toward the second core, and
the third coil pattern includes a third winding pattern wound around the second core, and a third extension pattern wound to surround the first core and the second core, and
the fourth coil pattern includes a fourth winding pattern wound around the second core, and a fourth extension pattern that extends from the fourth winding pattern toward the first core.

10. The coil electronic component of claim 9, wherein
a winding direction of the first winding pattern and a winding direction of the second winding pattern are opposite to each other, and
a winding direction of the third winding pattern and a winding direction of the fourth winding pattern are opposite to each other.

11. The coil electronic component of claim 10, wherein
the winding direction of the first winding pattern and the winding direction of the third winding pattern are the same as each other, and
the winding direction of the second winding pattern and the winding direction of the fourth winding pattern are the same as each other.

12. The coil electronic component of claim 11, wherein
the winding direction of the first winding pattern and a winding direction of the first extension pattern are the same as each other, and
the winding direction of the third winding pattern and a winding direction of the third extension pattern are the same as each other.

13. The coil electronic component of claim 3, wherein
the first coil pattern includes a first winding pattern wound around the first core, and a first extension pattern that extends from the first winding pattern toward the second core,
the second coil pattern is wound to surround the first core and the second core,
the third coil pattern includes a third winding pattern wound around the second core, and a third extension pattern that extends from the third winding pattern toward the first core, and
the fourth coil pattern is wound to surround the first core and the second core.

14. The coil electronic component of claim 13, wherein
a winding direction of the first winding pattern and a winding direction of the second winding pattern are opposite to each other, and
a winding direction of the third winding pattern and a winding direction of the fourth winding pattern are opposite to each other.

15. The coil electronic component of claim 14, wherein
the winding direction of the first winding pattern and the winding direction of the third winding pattern are the same as each other, and
the winding direction of the second winding pattern and the winding direction of the fourth winding pattern are the same as each other.

16. The coil electronic component of claim 1, further comprising:
a first connection electrode that is embedded in the magnetic body and connects the first external electrode to the first coil,
a second connection electrode that is embedded in the magnetic body and connects the second external electrode to the first coil,
a third connection electrode that is embedded in the magnetic body and connects the third external electrode to the second coil, and
a fourth connection electrode that is embedded in the magnetic body and connects the fourth external electrode to the second coil.

17. The coil electronic component of claim 16, further comprising:
a first dummy pad that is embedded in the magnetic body, and is spaced apart from the first coil, and through which the first connection electrode passes; and
a second dummy pad that is embedded in the magnetic body, and is spaced apart from the second coil, and through which the second connection electrode passes.

18. The coil electronic component of claim 1, wherein
the magnetic body further has a third surface and a fourth surface that face each other and connect the first surface and the second surface, and
the first coil includes a first lead-out portion extending from the third surface and connected to the first external electrode, and a second lead-out portion extending from the fourth surface and connected to the second external electrode, and
the second coil includes a third lead-out portion extending from the fourth surface and connected to the third external electrode, and a fourth lead-out portion extending from the third surface and connected to the fourth external electrode.

19. The coil electronic component of claim 1, wherein
the magnetic body further has a third surface and a fourth surface that face each other and connect the first surface and the second surface, and
the first coil includes a first lead-out portion extending from the third surface and connected to the first external electrode, and a second lead-out portion extending from the third surface and connected to the second external electrode, and
the second coil includes a third lead-out portion extending from the fourth surface and connected to the third external electrode, and a fourth lead-out portion extending from the fourth surface and connected to the fourth external electrode.

20. The coil electronic component of claim 1, wherein the magnetic body further has (i) a first cover layer between the first surface and the first coil and between the first surface and the second coil, and (ii) a second cover layer between the second surface and the first coil and between the second surface and the second coil, and
the first cover layer is thicker than the second cover layer.
